(19) United States
(12) Patent Application Publication
(10) Pub. No.: US 2026/0309525 A1
(43) Pub. Date: Oct. 8, 2026

(54) SENSING SYSTEM AND A PROCESS FOR DETECTING ONE OR MORE PHYSICAL PARAMETERS OF AN UNDERCARRIAGE AND/OR A VEHICLE, AND UNDERCARRIAGE AND VEHICLE PROVIDED WITH SAID SENSING SYSTEM

(71) Applicants: Berco S.p.A., Copparo/Ferrara (IT); thyssenkrupp AG, Essen (DE)

(72) Inventors: Andrea BIANCHI, Ferrara (IT); Carolina MIOZZI, Roma (IT); Sara AMENDOLA, Roma (IT); Nicola D'UVA, Isemia (IT)

(73) Assignees: Berco S.p.A., Copparo/Ferrara (IT); thyssenkrupp AG, Essen (DE)

(21) Appl. No.: 19/483,532

(22) PCT Filed: May 10, 2024
(86) PCT No.: PCT/EP2024/062915

§ 371 Date: Nov. 11, 2025

(30) Foreign Application Priority Data
May 12, 2023 (IT) 102023000009558

(51) Int. Cl. G01D 11/30; G01D 21/00

(52) U.S. Cl. CPC G01D 11/30; G01D 21/00

(57) ABSTRACT

A sensing system for detecting physical parameters of a part to be monitored comprises a sensor assembly in turn comprising: A) a fixing element in turn comprising a fixing pin to be fixed to the part to be monitored; B) a sensing circuit configured for detecting one or more physical parameters of the part to be monitored; C) a fixing interface configured for being fixed to the fixing element; D) a protecting housing to be fixed to the fixing interface and containing at least part of the sensing circuit so as to protect it from the external environment, mechanical stresses, chemical substances, dirt, liquids, dust, atmospheric agents, heat, cold, thermal shocks.

### FIELD OF THE INVENTION

The present invention relates to a sensing system and a process for detecting one or more physical parameters of an undercarriage and/or a vehicle, such as a tracked vehicle.

The present invention also relates to an undercarriage and a vehicle provided with said sensing system.

### BACKGROUND ART

Undercarriages of tracked vehicles often operate in harsh environments and conditions for long periods.

Such conditions often risk to reduce the lifespan of the affected parts, for example overheating them, loosening threaded connections and more generally altering some physical parameters of the undercarriage with respect to the design values.

Hence it would be desirable to have a distributed net of sensors able to detect in real time temperature, tightening of bolts, screws and other threaded connections and other physical parameters of the undercarriage, for example for timely planning regular or supplementary maintenance operations.

Setting up a distributed net of sensors requires an easy, cheap and quick assembling of each sensor, for example reducing an minimum operations of drilling, milling and other machining steps.

Furthermore the sensors need to be protected from the abovementioned harsh environment, for example from mechanical stresses, shocks, dirt, moisture, water or chemically aggressive substances or conditions or influence factors.

A scope of the present invention is overcoming the above described drawbacks of the state of the art and in particular providing a system and a process for detecting physical parameters of an undercarriage or a tracked vehicle involving easier, quicker and cheaper assembling operations and allowing a distributed sensor network be provided at lower costs.

### SUMMARY OF THE INVENTION

According to a first aspect of the present invention, this scope is achieved with a sensing system having the features according to claim 1.

In a sensing system according to a particular embodiment of the invention, the fixing interface (7) comprises one or more of the following entities: a washer, a plate, a shell.

These arrangements allow the sensing circuit and the protecting housing be more easily fixed and at lower costs to or close to the part to be monitored, and allowing the fixing interface be obtained easier from standard parts.

In a sensing system according to a particular embodiment of the invention, the fixing element (3) comprises one or more of the following entities: a bolt, a fixing pin (5) forming at least partially threaded flanks, a shoulder (320) configured for resting against the fixing interface (7), a fixing pin (5) configured for extending through the fixing interface (7), a standard bolt, a standard fixing pin (5) forming at least partially threaded flanks.

These arrangements allow the sensing circuit and the protecting housing be more easily fixed and at lower costs to or close to the part to be monitored, and allowing the fixing element be obtained easier from standard parts.

In a sensing system according to a particular embodiment of the invention, the sensing circuit (6) is at least partially embedded in, contained in and/or fixed to the protecting housing (9, 9′, 9″, 9^{III}).

This way the sensing circuit is protected from mechanical or chemical stresses and from the outer environment, and in any case a network of distributed sensors can be easier provided and operate in aggressive environments such as those surrounding undercarriages and/or tracked vehicles during operation.

In a sensing system according to a particular embodiment of the invention, the sensing circuit (6) is partly or wholly arranged out of the fixing element (3).

This measure helps obtaining the sensing system from standard parts and reduces the modifications of the undercarriage parts necessary for fixing the sensing system thereto.

a sensing system according to a particular embodiment of the invention, the sensor assembly (1, 1′, 1″) is provided with an antenna (64, 64″) is configured for wirelessly transmitting signals from and to the sensing circuit (6) and/or for harvesting energy of electromagnetic fields irradiating or however surrounding the sensor assembly (1, 1′, 1″) and powering the sensor assembly (1, 1′, 1″), for example powering the sensing circuit (6).

This arrangement allows obtaining more easily a network of distributed sensors and increasing the number of sensors of that network.

In a sensing system according to a particular embodiment of the invention, the antenna (64″) is a slot antenna (640).

This arrangement simplifies and enhances protecting a sensing circuit and at the same time helps such sensing circuit to wirelessly transmit and receive signals from a harsh environment such as that where undercarriages and/or tracked vehicles often operate, and allows enhancing the wireless transmission or reception of signals from zones of an undercarriage or tracked vehicle which cannot be reached or are difficult to be reached by transmission cables.

In a sensing system according to a particular embodiment of the invention, the slot antenna (64″, 640) is integrally formed in the protecting housing (9″, 9^{III}).

This arrangement simplifies the construction of the antenna and the protecting housing reducing the manufacturing costs thereof, and allows improvement of the wireless transmission.

In a sensing system according to a particular embodiment of the invention, the slot antenna (64″, 640) is formed as a through-slot crossing a wall of the protecting housing (9″).

This arrangement simplifies the construction of the antenna and the protecting housing reducing the manufacturing costs thereof, and further improves the wireless transmission.

In a sensing system according to a particular embodiment of the invention, the fixing element (3) forms an outer edge (72) and the protecting housing (9, 9′, 9″, 9^{III}) is configured for engaging the outer edge (72) so as to be fixed to it.

This measure simplifies fixing the protecting housing to the fixing element, in particular through standard parts.

In a sensing system according to a particular embodiment of the invention, the fixing element (3) forms an outer threaded edge (72) and the protecting housing (9, 9′, 9″, 9^{III}) is configured for being screwed on the outer threaded edge (72).

This measure further simplifies and makes cheaper fixing the protecting housing to the fixing element, in particular through standard parts.

In a sensing system according to a particular embodiment of the invention, the sensing circuit (6) is configured for measuring or however detecting one or more of the following physical parameters: a temperature, the tightening of a threaded connection.

This measure allows a better monitoring of distributed parameters of an undercarriage and/or tracked vehicle, enhancing fault prevention, preventive maintenance and optimisation of the vehicle operation.

In a sensing system according to a particular embodiment of the invention, the sensing circuit (6) comprises one or more of the following entities: a RFID tag, an NFC tag, a Bluetooth emitter and/or receiver, a radiofrequency emitter and/or receiver, a passive radiofrequency emitter and/or receiver, a radiofrequency emitter and/or receiver configured for being wirelessly powered through harvesting energy of an external power source.

This measure allows providing a distributed sensor network at lower costs; furthermore allows reducing the maintenance costs and reliability of the wireless transmissions of the sensors.

According to a second aspect of the present invention, this scope is achieved with an undercarriage assembly having the features according to claim 11.

According to a third aspect of the present invention, this scope is achieved with an undercarriage assembly having the features according to claim 12.

In an undercarriage according to a particular embodiment of the invention, the one or more sensor assemblies (1, 1′, 1″) and one or more reader devices (11) are configured for communicating one with another wirelessly.

This measure makes easier to provide a distributed sensor network in an undercarriage and/or tracked vehicle.

In an undercarriage according to a particular embodiment of the invention, the one or more sensor assemblies (1, 1′, 1″) are configured for being wirelessly powered by the one or more reader devices (11) through energy harvesting.

This measure allows reducing maintenance costs, in particular avoiding periodic replacement of electric batteries.

According to a fourth aspect of the present invention, this scope is achieved with a tracked vehicle having the features according to claim 13.

According to a fifth aspect of the present invention, this scope is achieved with a process for detecting one or more physical parameters of an undercarriage assembly or of a vehicle, having the features according to claim 15.

In a process according to a particular embodiment of the invention:
the protecting housing (9, 9′, 9″, 9^{III}) of said at least one sensor assembly (1, 1′, 1″) forms an inner cavity (90);
when the protecting housing (9, 9′, 9″, 9^{III}) of said at least one sensor assembly (1, 1′, 1″) is fixed to the fixing interface (7), the fixing interface (7) substantially closes the inner cavity (90) causing the protecting housing (9, 9′, 9″, 9^{III}) of said at least one sensor assembly (1, 1′, 1″) to protect at least part of the sensing circuit (6) from the environment out of the protecting housing (9, 9′, 9″, 9^{III}) and/or from one or more of the following agents: mechanical stresses, chemical substances, dirt, liquids, dust, atmospheric agents, heat, cold, thermal shocks.

This measure allows a better monitoring of distributed parameters of an undercarriage and/or tracked vehicle, allowing the sensors operate in a harsh environment.

The dependent claims are directed to further features of the invention.

Further advantages which can be achieved with the present invention will appear more evident for the skilled reader, from the following detailed description of particular and non limiting embodiments, described with reference to the following schematic figures.

### LIST OF FIGURES

FIG. 1 shows a side view, partially sectioned, of a sensor assembly according to a first particular embodiment of the present invention;

FIG. 2 shows a perspective view of the washer of the Sensor assembly of FIGS. 1, 4, 5

FIG. 3 shows a side view of the protecting housing of the sensor assembly of FIGS. 1, 4 sectioned according to a section plane crossing the longitudinal axis of the bolt of the respective sensor assembly;

FIG. 4 shows a side view, partially sectioned, of a sensor assembly according to a second particular embodiment of the present invention;

FIG. 5 shows a side view, partially sectioned, of a sensor assembly according to a third particular embodiment of the present invention;

FIG. 6 shows a perspective view of a first protecting housing which can be part of the sensor assembly of FIG. 5, partially sectioned according to an ideal plane crossing the axis of the protecting housing;

FIG. 7 shows a first perspective view of a second protecting housing which can be part of the sensor assembly of FIG. 5;

FIG. 8 shows a second perspective view of the protecting housing of FIG. 7, partially sectioned according to an ideal plane crossing the axis of the protecting housing;

FIG. 9 shows a perspective view of a main supporting frame of a tracked vehicle be provided with one or more sensor assemblies of FIG. 1-8 and/or with the undercarriage assemblies of FIGS. 10-13;

FIG. 10 shows a side view of a part of an undercarriage assembly of FIG. 11, 12 or 13, observed from the direction Y from the inside to towards the outside of the vehicle, according to a fourth particular embodiment of the present invention, which can comprise a plurality of sensor assemblies of FIG. 1, 4 or 5;

FIG. 11 shows a bottom view of a part of a undercarriage assembly provided with a sensing system according to a fifth particular embodiment of the present invention;

FIG. 12 shows a bottom view of a part of an undercarriage assembly provided with a sensing system according to a sixth particular embodiment of the present invention;

FIG. 13 shows a bottom view of a part of an undercarriage assembly provided with a sensing system according to a seventh particular embodiment of the present invention;

FIG. 14 shows a block diagram of a sensing system according to a particular embodiment of the present invention.

### DETAILED DESCRIPTION

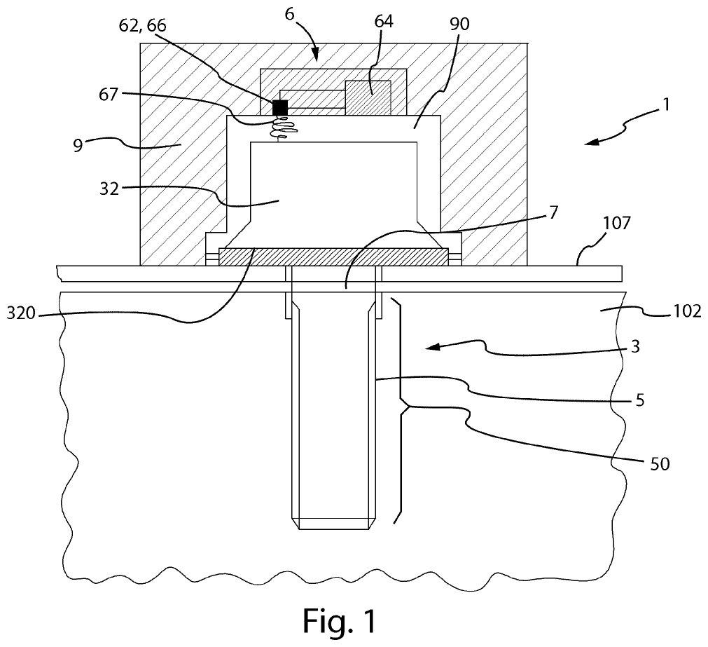

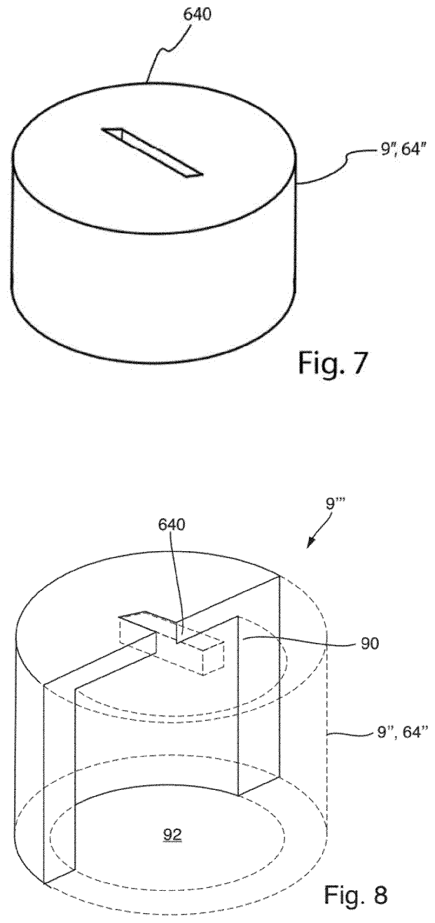

FIGS. 1-14 relate to a sensing system according to some particular embodiments of the present invention.

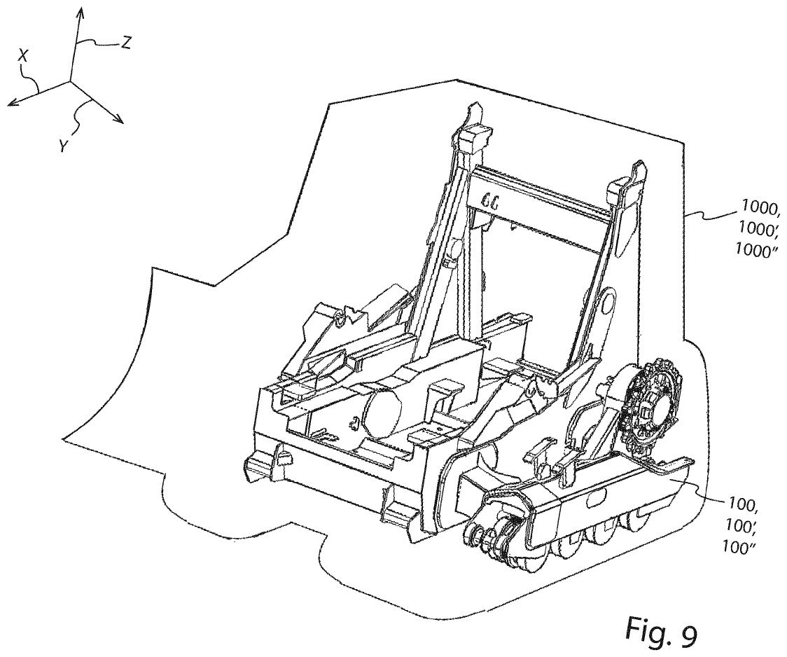

The sensing system according to the present invention is configured for detecting physical parameters of a mechanical part to be monitored such as a roller 102 of an undercarriage assembly 100, 100′, 100″ of a tracked vehicle 1000, 1000′, 1000″ (FIG. 9-13).

The tracked vehicle 1000, 1000′, 1000″ can be for example a bulldozer, excavator, grader, mobile drill, tractor, crawler, tank, heavy equipment vehicle, an earthmoving machine, a vehicle to be used for example in mining, heavy constructions, demolition and waste disposal.

Such sensing system comprises a sensor assembly 1, 1′, 1″ in turn comprising:
a fixing element 3 in turn comprising a fixing pin 5 configured for being fixed to the roller 102 or another part of the undercarriage 100, 100′, 100″ or vehicle 1000, 1000′, 1000″ to be monitored;
a sensing circuit 6, 6′, 6″ configured for detecting one or more physical parameters of the roller 102 or another part to be monitored 102;
a fixing interface 7 configured for being fixed to the fixing pin 5 or more generally to the fixing element 3;
a protecting housing 9, 9′, 9″, 9^{III}configured for being fixed to the fixing interface 7 and containing at least part of the sensing circuit 6 so as to protect it from the environment out of the protecting housing 9, 9′, 9″, 9^{III} itself and/or from one or more of the following entities/agents/influence factors: mechanical stresses
such as impacts, pressures, thrusts, vibrations-, chemical substances, dirt, liquids, dust, atmospheric agents, heat, cold, thermal shocks.

The sensing circuit 6, 6′, 6″ can comprise a sensor logic unit 62, an antenna 64, 64″, an exciter 63 for powering the antenna 64, 64″ and/or a sensing portion 66 (FIGS. 1, 4, 5).

Like for example in the embodiment of FIG. 1, the sensor logic unit 62 and the sensing portion 66 can be made as parts of the same electronic integrated circuit or another electric and/or electronic circuit.

Alternatively the sensing portion 66 can comprise for example a thermocouple made as part of the same integrated circuit of which the sensor logic unit 62 and/or the antenna 64 is also part, or as a part external to and connected to such integrated circuit.

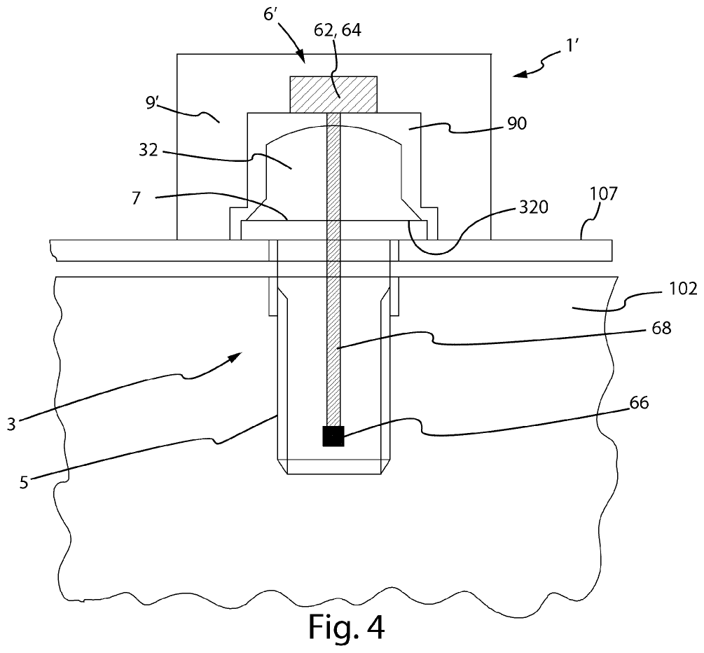

The antenna 64 can comprise for example a part of a printed circuit, printed for example on a relatively rigid board or on an insulating film or another relatively flexible insulating support (FIGS. 1, 4).

The antenna 64, 64″ is configured for transmitting signals from and to the sensor logic unit 62 or more generally from and to the sensing circuit 6 and/or for harvesting energy of electromagnetic fields irradiating or however surrounding the sensor assembly 1, 1′, 1″ and powering the sensing circuit 6.

Preferably the fixing pin 5 forms at least partly threaded flanks 50 (FIGS. 1, 4, 5).

This means that at least a part of the overall length of the flanks 50, or preferably their whole length, can form a thread configured for being screwed in a respective roller 102 or another part of the undercarriage 100, 100′, 100″.

Advantageously the fixing element 3 comprises a shoulder element 32 such as a head of a bolt or screw configured for resting against the fixing interface 7, for example against one of the main faces of the washer 7.

To this purpose the fixing element 3 can comprise a bolt (FIGS. 1, 4, 5) the head 32 of which forms a surface facing the threaded pin 5 and in turn forming the shoulder 320 configured for resting against the fixing interface 7, for example against one of the main faces of the washer 7.

Advantageously the bolt 3 or other fixing element 3 is a standard part, that is its shape, dimensions and other features 3 comply with national or international standards, such as DIN- or UNI-EN norms: this way a pre-existing or previously designed undercarriage or vehicle can be provided with sensor assemblies 1 with lower additional costs and less or no need of modifying the undercarriage or vehicle respectively, for example with less or no needs at all of milling, drilling or machining the vehicle parts where the fixing element 3 needs to be mounted.

The protecting housing 9, 9′, 9″, 9^{III} can have for example the shape of a cap or hood and preferably forms a substantially rigid shell.

The protecting housing 9, 9′, 9″, 9^{III} preferably contains and protects at least part of one or more of the following entities: the sensor logic unit 62, the exciter 63, the antenna 64, the sensing portion 66, the head 32 or other shoulder element 32, the fixing pin 5.

The exciter 63 can be present or absent depending on which kind of antenna 64, 64″ or protective housing 9, 9′, 9″ are used; for example if the cap or another protective housing 9, 9′, 9″, 9^{III} is made of polymeric material or another electrically non-conducting material the exciter 63 can be for example absent.

If the cap or another protective housing 9, 9′, 9″ is made of steel, another metallic material or another electrically conducting material, the sensor assembly 1, 1′, 1″ is preferably provided with the exciter 63.

To this purpose protective housing 9 forms an inner cavity 90 configured for containing one or more of the abovementioned entities.

The cavity 90 forms a mouth 92 through which the abovementioned entities can enter the cavity 90.

Preferably the fixing interface 7 comprises a metal sheet shaped for example like a plate or a shell, such as a convex and concave shell, a single curvature or double curvature shell.

More preferably the fixing interface 7 comprises a washer (FIGS. 1,2, 4, 5).

The washer 7 has preferably the shape of a substantially planar disc (FIGS. 1, 2, 4, 5).

Preferably the washer 7 or other fixing interface 7 forms a through hole 70 preferably arranged at or close to the centre of the washer 7.

Preferably the through hole 70 is configured for being crossed by the fixing pin 5.

The sensor assembly 1, 1′, 1″ is provided with a housing fixing system through which the protective housing 9 can be fixed to the fixing interface 7.

Preferably the washer 7 or other fixing interface 7 forms an outer edge 72 which in turn forms a part of the housing fixing system.

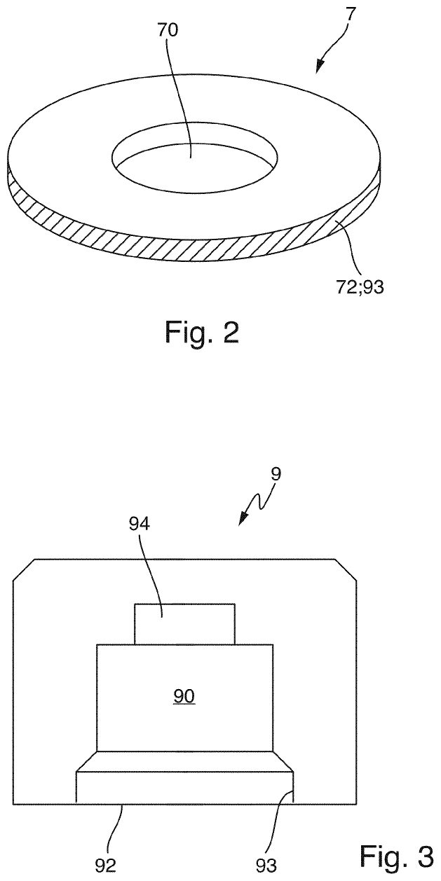

The plan view of the outer edge 72 preferably has a substantially circular shape (FIG. 2).

The mouth 92 or another portion of the protective housing 9 can form another part of the housing fixing system.

Preferably the outer edge 72 of the washer 7 or another fixing interface 7 and the mouth 92 of the protective housing 9 form respective threadings 93 configured for being screwed one with another (FIG. 3)

In other embodiments the outer edge 72 of the washer 7 or another fixing interface 7 and the mouth 92 of the protective housing 9—or the protective housing 9 in general—can engage one another and be fixed one to another through other mechanical couplings, for example through a snap- or bayonet coupling.

To this purpose the outer edge 72 of the washer 7 or another fixing interface 7 can form an undercut to which the protective housing 9 can be hooked.

The sensing circuit 6 advantageously comprises a receiver and/or emitter of radio frequency electromagnetic waves such as a transponder.

Preferably the receiver and/or transmitter is configured for receiving and or emitting electromagnetic waves at a frequency comprised between 100 kHz-12 GHz and more preferably at Ultra High Frequencies (UHF).

Preferably the sensing circuit 6 comprises an RFID (Radio Frequency IDentification) tag or an NFC (Near Field Communication) tag, a Bluetooth emitter and/or receiver, a battery or another accumulator or electric energy or power supply which can be contained within the protecting housing 9, 9′, 9″.

The RFID, NFC tag, Bluetooth emitter and/or receiver, the logic unit 62 or other kinds of logic unit can comprise for example a microchip or another microprocessor and/or a recording medium such as a digital memory such as a RAM, FRAM, EEPROM and/or a flash memory.

Such digital memory or other recording medium can be configured for storing the data measured by the sensing circuit 6 for example until they are transmitted to the reader device 11 or another external receiver (not shown).

Advantageously the RFID tag or another sensing circuit 6 is passive, that is it is not powered by an onboard power supplier such as a battery arranged in, fixed to or close to the sensor assembly 1, 1′, 1″ but it is wirelessly powered through harvesting energy of radio waves or other electromagnetic waves emitted by an external source such as the reader device 11 and irradiating the sensor assembly 1, 1′, 1″.

The protecting housing 9, 9′, 9″ is preferably made of a material enough mechanically and/or chemically resistant for protecting the parts contained in the cavity 90, for example the parts of the sensing circuit 6.

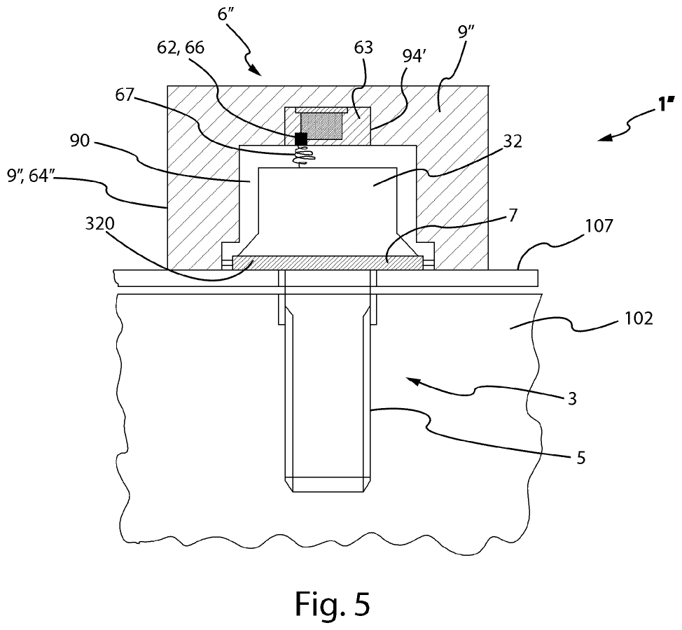

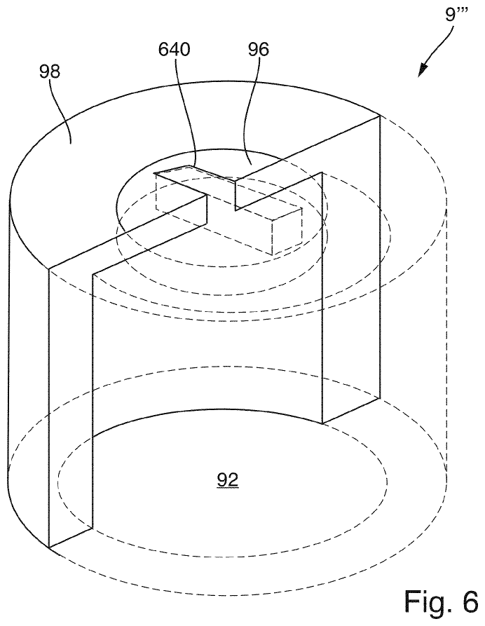

To this purpose the protecting housing 9, 9′, 9″ is preferably made of a metallic material such as steel (FIGS. 5, 6) or a hard non-metallic material (FIGS. 1, 4).

Examples of non-metallic materials of the protecting housing 9, 9′ are polyamide, polyamide reinforced with carbon fibres, polycarbonate, Polyether ether ketone (PEEK), other polyaryletherketone (PAEK) or other engineering plastics providing a good protection against impacts and other mechanical stresses.

The protecting housing 9, 9′, 9″ can be made of an electrically conducting material or an electrically non-conducting material.

The cavity 90 can form an inner recess 94, 94′ recessed relative to the walls of the rest of the cavity 90 and configured for containing at least a part of the sensing circuit 6, such as for example the abovementioned logic unit 62, the RFID tag, NFC tag, the microchip, microprocessor and/or recording medium (FIG. 1-5).

Advantageously the protecting housing 9″, 9^{III} can be or comprise an electrically conductive part 96 (FIGS. 5, 6, 8).

Like in the embodiment of FIG. 6, the protecting housing 9^{III} can comprise an electrically isolating part 98 surrounding the electrically conductive part 96, for example because the electrically conductive part 96 is fitted or embedded in the electrically isolating part 98.

Advantageously the protecting housing 9″ is made possibly wholly made—of an electrically conductive material; in this case the electrically conductive part 96 forms the whole protecting housing 9″, 9^{III}.

The electrically conductive part 96 or the protecting housing 9″ as a whole is configured for operating as an antenna for transmitting signals from and to the sensor logic unit 62 or more generally the sensing circuit 6 and/or for harvesting energy of electromagnetic fields irradiating or however surrounding the sensor assembly 1, 1′, 1″ and powering the sensing circuit 6.

To this purpose preferably at least one portion of the electrically conductive part 96 faces the environment surrounding the sensor assembly 1, 1′, 1″ and/or is exposed to such external environment.

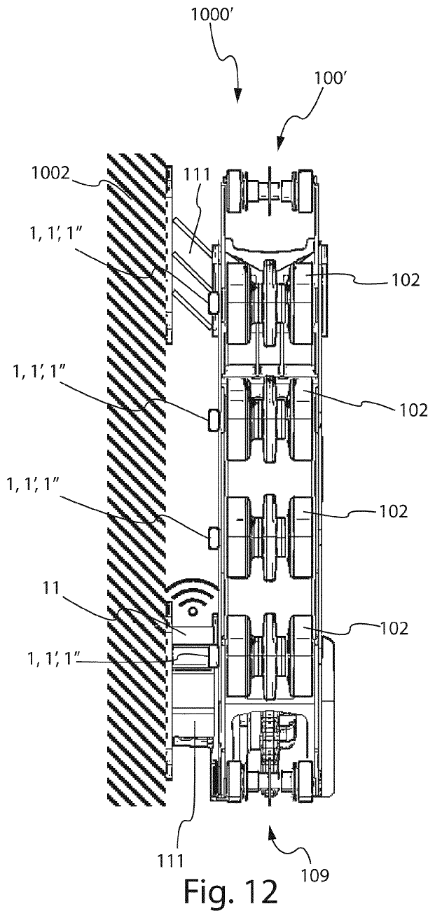

In a particular embodiment the electrically conductive part 96 or portion of the protecting housing 9″, or more generally the electrically conductive protecting housing 9″ forms one or more slot antennas 64″ through which the sensing circuit 6 can transmit and/or receive data, for example transmitting to and/or receiving data from the reader device 11 described later (FIG. 12).

Each slot antenna 64″ forms one or more slots 640 configured for emitting and or receiving electromagnetic waves of a suitable wavelength for transmitting to and/or receiving data or other information from the reader device 11 or other devices.

Each slot antenna 64″ can be made a through opening across the whole thickness of the electrically conductive part 96 or more generally of the conductive protecting housing 9″ (FIG. 6-8), or as a groove the depth of which extends over only a part of the thickness of the electrically conductive part 96 or more generally of the conductive protecting housing 9″.

Each slot antenna 64″ is preferably excited by a suitable exciter 63.

Each slot 640 has a length preferably comprised between 5-20 millimetres and/or a width preferably comprised between 1-20 millimetres.

The slot antenna or antennas 64″ allow an efficient transmission using a metallic cap or other protecting housing 9″, which can very validly protect the sensing circuits providing a very strong protection against impacts and mechanical and chemical stresses in general.

When it is mostly or wholly made of polymeric material or another electrically non-conductive material, the protecting housing 9, 9′, 9″ preferably does not form slots, through holes, fissures or other through openings, for example through which during the normal operation of the sensor assembly the inner cavity 90 is in fluid communication with the external environment; the absence of such through openings increases the mechanical strength of the protecting housing 9, 9′, 9″ (FIGS. 1, 4).

The sensing portion 66 is configured for detecting one or more physical parameters of the sensor assembly 1, 1′, 1″ and/or of parts or environment surrounding the sensor assembly 1, 1′, 1″, such as temperature of a part, of ambient air or other air, wear of part, the tightening of the threaded connection of the threaded flanks 50 of the fixing pin 5 with the roller 102 or other part of the undercarriage assembly 100.

Advantageously a part of the sensing circuit 6—such as the logic unit 62, the antenna 64, the sensing portion 66, the RFID-, NFC tag or Bluetooth emitter and/or receiver—or more advantageously the whole sensing circuit 6 can be embedded in or however fixed to the protecting housing 9, 9′, 9″.

Advantageously the sensing circuit 6 is arranged outside of the bolt or other fixing element 3.

To this purpose, preferably no part of the sensing circuit 6—such as the logic unit 62, the antenna 64, the sensing portion 66, the RFID-, NFC tag or Bluetooth emitter and/or receiver—and all the more neither the whole sensing circuit 6 is embedded in or however fixed to the bolt or other fixing element 3.

This way less or no modifications to a standard bolt are required for using it as fixing element 3 of the sensor assembly 1, 1′, 1″.

When the sensing portion is configured for detecting the temperature of an undercarriage part, the sensing portion 66 can be connected to that part through a solid body 67 in contact with the undercarriage part and transmitting heat from the latter to or towards the sensing portion by thermal conduction.

The solid body 67 is also conventionally referred to as thermal bridge body 67 in the present description.

To this purpose the thermal bridge body 67 has a greater thermal conductivity that the surrounding material or substance in which it is embedded or by which it is surrounded.

The thermal bridge body 67, 67′ can have the overall shape of a coil, a spiral, a rod, a wire, a ribbon, an elongated and rectilinear body.

The thermal bridge body 67, 67′ comprises for example a helical spring contacting both the sensing portion 66 and the head of the bolt 5 (FIGS. 1, 4), another fixing element 3 or another undercarriage part.

Alternatively the sensing portion 66—which operates substantially as a probe—can be embedded or however arranged for example at or close to the distal end of the fixing pin 5 or more generally in the fixing pin 5 (FIG. 4): this arrangement allows the temperature of the roller 102 or other part of the undercarriage in which the fixing pin is screwed, fitted or otherwise arranged into, be measured or however sensed quicker—that is with a shorter delay—than with the arrangements of FIGS. 1,2,4.

Like in the arrangement of FIG. 4 preferably the sensing portion 66 is electrically connected to the rest of the sensing circuit 6 through a shielded cable 68 or another electrical conductor shielded against undesired electromagnetic emissions.

The shielded cable or other shielded electrical conductor can extend for example along, through and/or within the fixing pin 5 and/or the fixing element 3 (FIG. 4).

In other embodiments, not shown, the shielded cable 68 can be replaced by a non-shielded or partially shielded electrical conductor or transmission line.

The sensing system according to the present invention preferably further comprises a reader device 11 configured for receiving the measures or other detections made by one or more sensor assemblies 1, 1′, 1″.

To this end the reader device 11 is configured for communicating wireless with one or more sensor assemblies 1, preferably through radio waves, for example in the frequencies suitable for communicating with RFID tags, NFC tags, Bluetooth emitter and/or receivers or in other frequencies comprised between 100 kHz-12 GHz.

Advantageously the reader device 11 is configured for emitting electromagnetic waves able to wireless power the sensing circuit 6 through energy harvesting, for example when the sensing circuit 6 comprises a passive RFID tag or a passive NFC tag.

The reader device 11 can be configured for receiving the measures or other detections made by one or more sensor assemblies 1, 1′, 1″—shortly “reading” or polling the one or more sensor assemblies 1—with a frequency comprised for example between 0.1-100 hertz, or between 0.1-30 hz, 1-20 hz or 5-10 hz, depending inter alia on the physical variables to be sensed and monitored.

If the sensing circuit 6 of the sensor assemblies 1 is passive, the reader device 11 is preferably configured for powering the sensor circuit 6 through energy harvesting, emitting sufficient electromagnetic power towards the sensor assemblies 1.

During the normal operation each reader device 11 can be arranged at a distance for example comprised between 0.0005-20 metres, or between 0.001-10 metres, 0.01-5 metres, 0.1-1 metre.

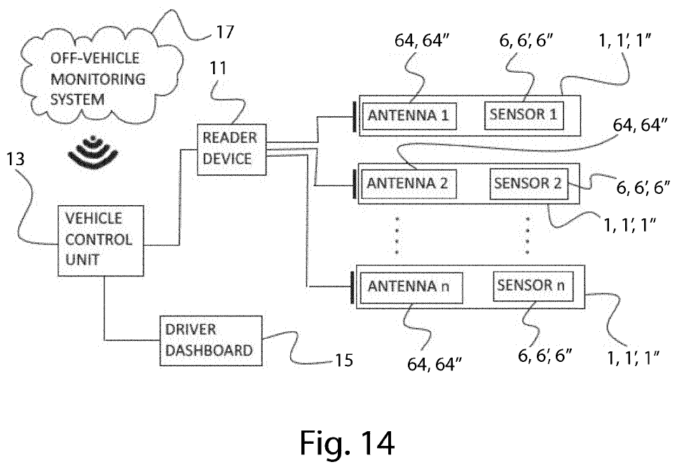

Each reader device can for example process the data acquired from the one or more sensor assemblies 1, 1′, 1″—for example filter, select, prune and/or aggregate them—and/or transmit them to another logic unit such as to a vehicle control unit 13 another higher level control unit, computer or display unit, such as a driver dashboard 15 (FIG. 14); said control unit, computer or display unit can for example be mounted on the vehicle of which the undercarriage 100, 100′, 100″ and the sensing system are part; alternatively said control unit, computer or display unit can be remote and for example belong to a computer cloud 17.

Each sensor assembly 1, 1′, 1″ can be mounted at or close to a suitable position—for example the most or almost most suitable position—for measuring one or more physical parameter of an undercarriage and/or vehicle.

FIGS. 9-13 show some examples of an undercarriage assembly, referred to as with the overall reference 100, 100′, 100″ of a tracked vehicle 1000, 1000′, 1000″ respectively.

The undercarriage assembly 100, 100′, 100″ can comprise for example a continuous crawler track 101 and a fixed frame 103 on which the continuous crawler track 101 is mounted and configured for rolling over the continuous crawler track 101 itself.

The fixed frame 103 can comprise a bearing structure in turn comprising metal plates, bars, struts, brackets, for example assembled through welding or threaded connections.

The fixed frame 103 can comprise for example one driving toothed wheel 105, one or more idle toothed wheels (not shown) and a plurality of idle rollers 102 configured for rolling over and/or against the inner side of the continuous crawler track 101.

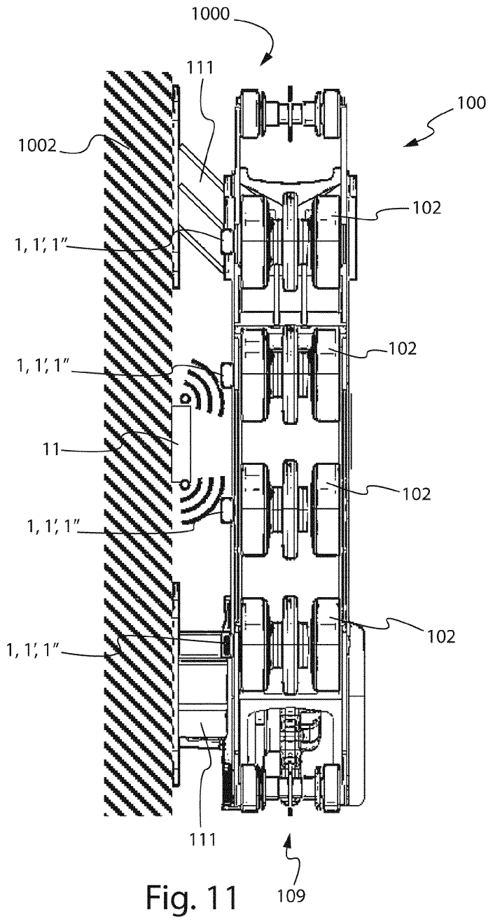

The outer surface of each idle roller 102 can be for example substantially cylindrical or substantially be a surface of revolution (FIG. 11-13) or a surface having a radial symmetry.

Each sensor assembly 1, 1′, 1″ can be mounted for example so as to fix a respective idle roller 102 to the fixed frame, for example to a bracket 107 fixing the roller 102 to the rest of the fixed frame 103.

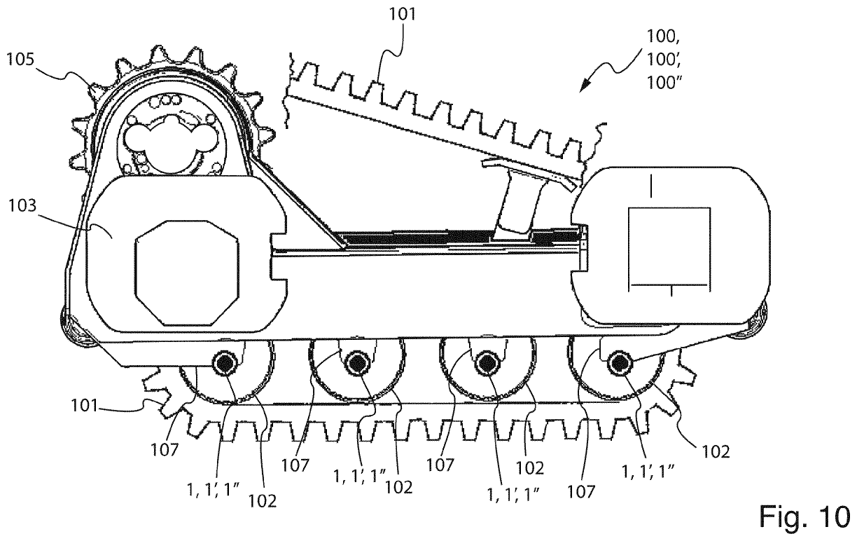

To this end the fixing pin 5 of the sensor assembly 1, 1′, 1″ can be arranged according to one or more of the following measures:
arranged coaxially to the rotation axis of the idle roller 102 (FIG. 10);
extend through a bracket 107 (FIGS. 1, 4, 5, 10) or another plate or part of the fixed frame 103 of the undercarriage assembly 100;
be screwed into the respective idle roller 102 (FIG. 1, 4, 5, 10-13);

This way the fixing pin 5 and the bolt 3 or other fixing element 3 assembles and holds in position the roller 102, without increasing the number of parts of the undercarriage 100, 100′, 100″, and at the same time allows the sensing portion 66 to measure or detect for example the temperature of the roller 102—detecting in particular and for example undesired overheatings—in a position very close to the roller 102—as for example in the particular embodiments of FIGS. 1, 5—or even within the roller 102, as shown for example in FIG. 4—making the measures or detection more precise and timely.

Advantageously a plurality of rollers 102, and more preferably all rollers 102 of the undercarriage assembly 100 is assembled through one or more respective sensor assemblies 1, 1′, 1″ and/or monitored through one or more respective sensor assemblies 1, 1′, 1″ (FIG. 1, 4, 5, 10-13), so as to measure or however detect the temperatures or other physical parameters of the undercarriage assembly 100 in a plurality of positions and/or parts and allowing a more precise, accurate and reliable monitoring of the operating conditions and foreseeing with greater advance possible malfunctions and potential failures.

Preferably the sensor assemblies 1, 1′, 1″ are arranged at or near to an end of the rollers 102 (FIG. 11-13).

Advantageously the sensor assemblies 1 are arranged at or near to the end of the rollers 102 which is closer to the inner part of the tracked vehicle or faces such inner part (FIG. 10-13): this latter arrangement allows the reader device 11 be arranged easier close or closer to the sensor assemblies 1 to be polled and in positions allowing a better transmission between the reader 11 and the sensor assemblies 1.

Furthermore this latter arrangement allows to make the energy harvesting which powers the sensor assemblies 1, 1′, 1″ more efficient: in fact if the sensor assemblies 1 are closer to the inside of the vehicle it is possible to better concentrate the electromagnetic radiation powering the assemblies 1, 1′, 1″ for example exploiting more reflections of the electromagnetic waves against metallic surfaces.

More generally, one or more of the sensor assemblies 1, 1′, 1″ are advantageously arranged so as to direct their radio waves emissions mainly towards the centre and/or the inside of the vehicle 1000, 1000′, 1000″.

This means for example that the direction corresponding to the higher radiation power density of the electromagnetic emissions of the sensor assembly 1, 1′, 1″ is directed towards the geometrical centre and/or the inside—such as the innermost or an inner zone—of the undercarriage 100, 100′, 100″ and/or of the vehicle 1000, 1000′, 1000″.

Some examples of possible arrangements of the reader device 11 enhancing the energy harvesting and the quality of the transmissions to and from the sensor assemblies 1, 1′, 1″ are shown in FIGS. 11-13.

The fixed frame of the undercarriage assembly can comprise two roller supports 109 each of which is connected to the rest of the vehicle 1000, 1000′, 1000″ and held in position through one or more arms 111 (FIG. 11-13).

The arms 111 preferably keep each roller support 109 spaced from the main body 1002 of the vehicle.

Each roller Support 109 can be provided as a substantially elongated frame (FIG. 10-13).

All rollers 102 to be arranged on the left or right side of the vehicle are preferably fixed to one respective roller support 109 (FIG. 10-13).

Advantageously the one or more reader devices 11 are fixed to the undercarriage 100 or to the main body of the vehicle so as to face the space interposed between the main body 1002 and a respective roller support 109 (FIG. 11-13).

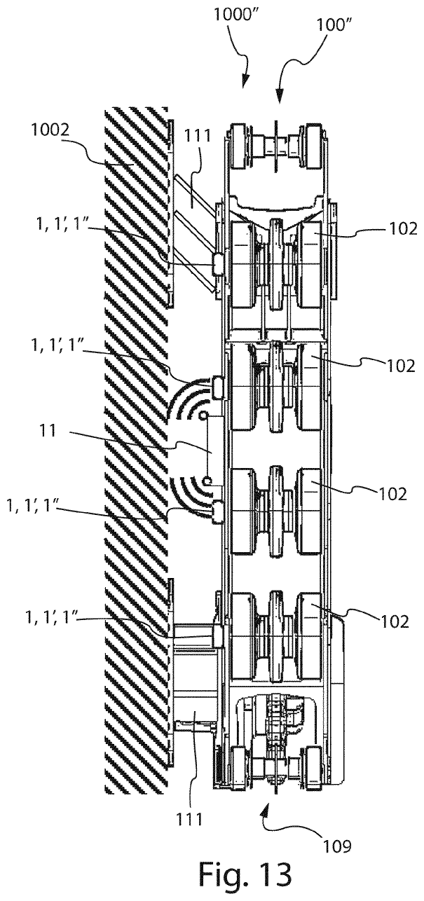

The reader device 11 can be fixed for example directly to the roller support 109 (FIG. 13), to one of the arms 111 (FIG. 12) or to a wall or another part of the vehicle facing the roller support 109 (FIG. 11).

A possible example of setting, operation and use of the abovementioned sensing system and respective undercarriage and tracked vehicle will now be described.

The threaded stem of a bolt 3 can be passed though the through hole 70 of a respective washer 7; the threaded stem acts as the abovementioned fixing pin 5.

Then the threaded stem can be screwed in a respective roller 102, preferably at or near the end of the roller 102 closer to the inner portion of the vehicle 1000, 1000′, 1000″, so as to block in position and press the washer 7 for example between the bolt head 32 and one of the brackets 107 of the fixed frame 103 (FIGS. 1, 4, 5).

The bolt or other fixing element 3 is preferably screwed so as to allow the respective roller 102 to rotate on itself and to rotate on or under the continuous track 101.

The protecting housing 9, 9′, 9″ can be then easily and quickly fixed to the washer 7 screwing it onto the threaded outer edge 72.

This way, or more generally when the protecting housing 9, 9′, 9″ is fixed to the washer 7 or another fixing interface 7, the inner cavity 90 is substantially closed and contains and protects partly or wholly the sensing circuit 6.

When assembling the protecting housing 7 with the bolt or other fixing element 3, the thermal bridge body 67 if any contacts or however gets thermally connected with the undercarriage part the temperature of which needs to be measured or however detected, such as the bolt head 32, the distal end of the fixing pin 5.

A plurality of sensor assemblies 1, 1′, 1″ can be screwed or however mounted on a plurality of respective rollers 102 with the previous assembling steps, so as to provide for example each roller support 109 with a plurality of sensor assemblies 1.

The reader device 11 can be fixed for example on or into an arm 111 holding the roller support 109 (FIG. 12), the roller support 109 itself (FIG. 13) or a portion of the vehicle 1000 preferably close to the Sensor assemblies 1, 1′, 1″ to be polled and/or powered (FIG. 11).

The reader device 11 can periodically emit electromagnetic waves or another electromagnetic radiation able to power the preferably passive RFID tags, NFC tags or other sensing circuits 6 of all the sensing assemblies 1, energizing their antennas 64 and allowing sensing circuits 6 to transmit to the reader device 11 their temperature detections or their detections of tightening or other physical parameters of the undercarriage assembly 100, 100′, 100″.

This way the sensing system is able to detect temperature, tightening or other physical parameters in a great number of parts or zones of the undercarriage assembly, forming a distributed sensor network, constantly monitoring them possibly in real time and allowing malfunctions be detected more sensibly and reliably, future failures be foreseen and preventive maintenance be planned more precisely and with greater advance.

The protecting housing 9, 9′, 9″ validly protects the sensing circuits 6 from impacts, pressures, dirt, dust and other mechanical and chemical stresses giving them a long operative life.

Using passive RFID tags, NFC tags or other sensing circuits 6 eliminates the need of periodically replacing onboard or however local batteries of each sensing assembly 1, saving a great amount of manual work and greatly simplifying the operation and maintenance of the sensing system as well as the construction of the sensing assembly 1 and the undercarriage 100, 100′, 100″.

A simple construction of the undercarriage 100, 100′, 100″ is also helped by the wireless communication between the sensing assemblies 1 and the reader device 11.

Using standardized bolts or other standardized parts as fixing element 3 and fixing to, embedding or housing the sensing circuit 6 partly or wholly in the protecting housing 9, 9′, 9″ and using the washer 7 or another fixing interface 7 reduces or eliminates the need of modifying a pre-existing vehicle, undercarriage or project thereof for setting the sensing system up.

embodiments previously described can be modified in several ways without departing from the scope of the present invention.

For example the RFID tag, NFC tag or other sensing circuit 6 can be not only passive but also active and powered for example through a local battery.

The sensor assemblies 1, 1′, 1″ can be fixed not only to the fixed frame 103 but also to the continuous crawler track 101.

The part to be monitored can be part not only of the fixed frame 103 but also of the continuous crawler track 101.

All constructional details can be replaced with technically equivalent elements.

A wording such as “A comprises B, C, D” or “A is made up of B, C, D” is to be understood as encompassing and disclosing the particular case of “A consists of B, C, D”.

Wordings such as “A comprises an element B” when not differently specified is to be understood as “A comprises one or more elements B”.

Mentions of a “first, second, third . . . n-th entity” merely intend to distinguishing the entities one from another but the mention of a n-th entity does not necessarily imply the existence of a first, second, third . . . (n−1)-th entity.

Examples and lists of possible alternatives are to be understood as non-exhaustive.

1.-15. (canceled)

16. A sensing system for detecting physical parameters of a part to be monitored, wherein the sensing system comprises a sensor assembly including:
a fixing element including a fixing pin configured for being fixed to the part to be monitored;
a sensing circuit configured for detecting one or more physical parameters of the part to be monitored;
a fixing interface configured for being fixed to the fixing element;
a protecting housing configured for being fixed to the fixing interface and containing at least part of the sensing circuit so as to protect it from the environment outside of the protecting housing and/or from one or more of the following agents or influence factors: mechanical stresses, chemical substances, dirt, liquids, dust, atmospheric agents, heat, cold, thermal shocks.

17. The sensing system according to claim 16, wherein the fixing interface comprises one or more of the following: a washer, a plate, a shell.

18. The sensing system according to claim 16, wherein the fixing element comprises one or more of the following: a bolt, a fixing pin forming at least partially threaded flanks, a shoulder configured for resting against the fixing interface, a fixing pin configured for extending through the fixing interface, a standard bolt, a standard fixing pin forming at least partially threaded flanks.

19. The sensing system according to claim 16, wherein the sensing circuit is at least partially embedded in, contained in and/or fixed to the protecting housing.

20. The sensing system according to claim 19, wherein the sensing circuit is partly or wholly arranged outside of the fixing element.

21. The sensing system according to claim 16, wherein the sensor assembly is provided with an antenna which is configured for wirelessly transmitting signals from and to the sensing circuit and/or for harvesting energy of electromagnetic fields irradiating or however surrounding the sensor assembly and powering the sensor assembly, for example powering the sensing circuit.

22. The sensing system according to claim 21, wherein the antenna is a slot antenna.

23. The sensing system according to claim 22, wherein the slot antenna is integrally formed in the protecting housing.

24. The sensing system according to claim 22, wherein the slot antenna is formed as a through-slot crossing a wall of the protecting housing.

25. The sensing system according to claim 16, wherein the fixing element forms an outer edge and the protecting housing is configured for engaging the outer edge so as to be fixed to it.

26. An undercarriage assembly configured for being assembled to the rest of a tracked vehicle, wherein the undercarriage assembly comprises:
a continuous crawler track;
a fixed frame on which the continuous crawler track is mounted and configured for rolling over the continuous crawler track itself; and
a sensing system according to claim 16;
wherein:
the fixed frame and/or the continuous crawler track form a part to be monitored;
the fixing element of at least one sensor assembly is fixed to the part to be monitored;
the sensing circuit of said at least one sensor assembly is configured for detecting one or more physical parameters of the part to be monitored;
the fixing interface of said at least one sensor assembly is fixed to the fixing element;
the protecting housing of said at least one sensor assembly is fixed to the fixing interface so as to contain at least part of the sensing circuit so as to protect it from the environment outside of the protecting housing and/or from one or more of the following agents or influence factors: mechanical stresses, chemical substances, dirt, liquids, dust, atmospheric agents, heat, cold, thermal shocks.

27. A process for detecting one or more physical parameters of an undercarriage assembly or a vehicle, comprising:
providing a sensing system according to claim 16;
fixing the fixing element of at least one sensor assembly to the part to be monitored;
detecting one or more physical parameters of the part to be monitored through the sensing circuit of said at least one sensor assembly;
fixing the fixing interface of said at least one sensor assembly to the fixing element;
fixing the protecting housing of said at least one sensor assembly to the fixing interface so as to contain at least part of the sensing circuit so as to protect it from the environment outside of the protecting housing and/or from one or more of the following agents or influence factors: mechanical stresses, chemical substances, dirt, liquids, dust, atmospheric agents, heat, cold, thermal shocks.
